(19) United States
(12) Patent Application Publication
(10) Pub. No.: US 2002/0076962 A1
(43) Pub. Date: Jun. 20, 2002

(54) Secure USB port and connector for wearable and portable computers

(76) Inventor: John W. Williams, Fairfax Station, VA (US)

Correspondence Address: JAMES J. RALABATE, 5792 MAIN ST., WILLIAMSVILLE, NY, 14221, US

(21) Appl. No.: 09/738,113

(22) Filed: Dec. 18, 2000

(51) Int. Cl. H01R 29/00

(52) U.S. Cl. 439/188

(57) ABSTRACT

The invention is a essentially a novel and useful USB-type computer port and connector which contains fastening means to secure the connector to the port. The invention solves the problem of accidental and unintentional disconnects specifically in the field of wearable and portable computing.

### Background of the Invention

In the late 1990's the Universal Serial Bus (herein after USB) standard became the preferred connection interface for peripheral devices in the personal computer (PC) industry. Initially supported by Microsoft Windows®98, this connection interface rapidly replaced the traditional serial and parallel ports as the connector of choice for peripheral devices. It provides an easy and fast, up to 450 Mbps with USB2, connection to the computer bus and established a new standard that peripheral device manufacturers could design to. Devices such as printers, digital cameras, keyboards, mice, external CD ROMS, etc. quickly adopted the USB standard. Laptop computer, desktop computers, wearable computers, and even PDA's are all manufactured with USB ports in order to take advantage of the variety of peripheral devices which are built around that architecture.

The computer end of the USB connector, otherwise known as the USB port, is a flush mounted open receptacle with a flat, rectangular card in the center bearing electrical contact points. The device end of the connector contains a sleeve which inserts into receptacle and surrounds the card making a mated electrical connection. Such connectors are ubiquitously well known in the art. The pervasiveness of this connector has increased utility to consumers, substantially increased data transfer rates over parallel bus speeds and reduced costs for manufacturers of peripheral devices due to standardization. Personal computer manufacturers typically incorporate one or more USB ports into their suite of I/O ports. This includes not only desktop manufacturers, but portable and wearable computer manufactures as well. Wearable, or user-supported computers are also well known in the computer arts. Examples include U.S. Pat. Nos. 5,844,824 and 5,305,244 (Newman et al) which describe a hands free, voice activated, user supported computer which is worn on the body of a user. Also teaching wearable computers are U.S. Pat. Nos. 5,285,398 (Janik I) and 5,491,651 (Janik II), which disclose a belt computer containing the elements or components of a computer. For the purposes of this disclosure and claims the term user supported or wearable computer will be taken mean a computer such as is taught by these patents or any other computer worn on the body of a user subject to the same physical conditions and environments.

The primary shortcoming of the USB architecture is that it is designed specifically with desktop applications in mind. The problems associated with fixed computers are completely different from problems encountered with wearable computers. Anytime an item such as a computer is in contact with, or in motion with, the human body over an extended period of time, special care must be given to the extra heat generated, the electrical connections and other wearable specific difficulties. Even problems associated with laptops are quite different from wearable problems, since laptops are usually supported on a desk or flat surface other than the human body. Electrical connections on a wearable become a major concern not generally important on laptops and desktops. The USB connector is not optimized to work with wearable computers that may be subject to motion while they are in use. The problem stems from the fact that there is no locking or clipping feature which secures the connector to the computer. Thus, when these mobile or wearable computers are being carried or worn by a user and exposed to walking or twisting of the user's body, devices which are connected to the computer via a USB connection are susceptible to becoming disconnected. This problem is unique to the field of mobile computing. The mere friction of the connector is typically enough resistance to maintain the connection when used on a desktop computers; peripheral devices may be added or removed periodically, but the entire connected system generally is in a fixed position. However, for wearable computers, this friction-based connection is not robust enough to insure continuity of connection when the computer itself is being moved around with the body of the user. As a result, accidental breaks in the connection can occur. Disconnections can result in loss of data, wasted time, and even rebooting of the computer itself, depending on the operating system being used. Thus, in the context of mobile computing, and especially wearable computing, there is a need for a new and useful USB connector which has a fastening mechanism which insures that the connection remains secure when the computer is subjected to motion and the cable itself is pulled on.

It is therefore an object of the present invention to create a USB connector and port which are devoid of the above mentioned shortcomings.

It is also an object of this invention to provide a unique USB connector and port.

It is another object of this invention to provide a USB connector and port primarily for use with wearable and mobile computers.

Another object of this invention to provide a USB connector and port which have a locking or securing mechanism to prevent accidental or unintentional disconnection from the computer when the computer is a mobile computer.

A further object of this invention is to provide a USB connector and port which will not become dislodged and needs to be manually connected and disconnected.

It is a further object of this invention to provide a novel USB connector and port which otherwise comports with the USB standard.

It is still a further object of this invention to provide a USB port with an integral dust cover which when used is retained by the same locking or securing mechanism as the USB connector.

These and other objects of the present invention are accomplished generally by a USB connector for use with mobile and in particular wearable computers which possesses a fastening means to secure the connector to the computer and is devoid of the shortcomings cited above.

### SUMMARY OF THE INVENTION

In a preferred embodiment the present invention is a novel USB-type connector and port standard for mobile and wearable computers which features a securing mechanism for preventing unintended disconnects due to extended ruggedized usage, motion or pulling on the cable. The USB port also possesses an attached dust cover for protecting its electrical contacts from dust and exposure when not in use, wherein the dust cover interfaces with the port in the same manner as a device's USB connector when mated with the computer's port. Optimumly, the dust cover will be attached at one end to the computer or port itself so that when not being used, it does not get separated from the computer.

In one embodiment, the device portion of the USB connector will connect to the USB port with a clip feature such as is known in the art to be utilized with RJ11 and 45-type connectors. These connector types are notoriously well known in the art. U.S. Pat. No. 5,044,981, Suffi et al discloses an RJ11 type connector, while U.S. Pat. No. 5993237, Kern, Jr. et al, discloses RJ-type connector jacks, including RJ11 and 45. The connector is characterized by a single clip at the top or bottom which is depressed to engage or remove the connection. Alternatively, the present invention could utilize two spring loaded clips on either side of the connector such as is used with Small Computer Systems Interface (SCSI) device cables. The user squeezes both sides of the connector simultaneously to engage and disengage the connection.

### BRIEF DESCRIPTION OF THE DRAWINGS

FIG. 1A illustrates an upward-looking view of an existing PC USB port.

FIG. 1B illustrates a straight-on view of an existing PC USB port.

FIG. 1C illustrates an existing USB-type connector from a peripheral device which mates with a USB port.

FIG. 2 illustrates an RJ45/11 style jack and wall plate such as is used for telephone and computer local area network connections respectively.

FIG. 3A illustrates a top view of an existing squeeze clip type connector such as a SCSI or VGA type connector in the natural position.

FIG. 3B illustrates a top view of an existing squeeze clip type connector such as a SCSI or VGA type connector in the “squeezed” position.

FIG. 4A illustrates a USB connector embodiment of the present invention using an RJ45/11 style fastener for securing the USB connector to the USB port.

FIG. 4B illustrates a USB port embodiment of the present invention using a RJ45/11 style receptacle for securing the USB connector to the USB port.

FIG. 5A illustrates a USB connector embodiment of the present invention using a squeeze clip style fastener for securing the USB connector to the USB port.

FIG. 5B illustrates a USB port embodiment of the present invention using squeeze clip style restraining brackets for securing the USB connector to the USB port.

FIG. 6A illustrates a protective cover embodiment for the present invention whereby the cover is fixably attached to the computer and uses an RJ45/11 type connection interface to securely connect to the USB port.

FIG. 6B illustrates a protective cover embodiment for the present invention whereby the cover is fixably attached to the computer and uses squeeze clip type connection interface to securely connect to the USB port.

### DETAILED DESCRIPTION OF THE DRAWINGS AND PREFERRED EMBODIMENTS

The invention is essentially a novel USB connector standard which provides for a physically secure connection between a peripheral USB-type device, such as a camera, printer, mouse or other peripheral, and the computer to which it is connected. The present invention has particular utility when used with user supported or wearable computers. For the purposes of this disclosure and claims the term USB connector will be taken to mean any connector built on the USB platform, including the standard full-sized USB connector, versions 1.1 and 2, and the mini-USB type connector. Currently the USB connector standard does not contain any fastening or securing mechanism to keep it connected. The reason for this is that most computers sold today are desktop computers. These computers usually sit on a table or desk and are not moved around. Thus, when peripheral devices are connected using the USB interface standard, the connector is generally not subject to motion or pulling. As a result the connector was designed to be easily attached and removed. However, mobile computing has a different set of requirements. Particularly wearable computing, where the computer is carried or worn on the body of the user and is subject to constant motion and potential pulling on the connector, there is a need for a USB connector which will not come unintentionally disconnected.

As to the physical design of the connector, the electrical contact portion will be identical to the existing USB standard to maximize compatibility and market acceptance of the mobile USB connector and to minimize changes to the production process of current USB connector manufacturers. However, the connector itself will incorporate a mechanical retaining mechanism to hold it in to place. For purposes of reference the portion of the USB connector that resides on the computer will be designated the USB port connector and the portion which comes from the peripheral device will be designated the USB connector. Preferably the retaining mechanism will possess pressure restrained clips on the short sides of the connector which can be squeezed with two fingers while the connector is being inserted. This method is more desirable than screw-in connectors because of the time involved in connecting and removing the screws, especially while the computer is worn and in use.

In one preferred embodiment, the male connector will contain two prongs which can be recessed by pinching either side of the connector. Once the pressure points are pinched the connector can be inserted into the female connector. The female portion will have two notches to physically receive the two prongs so that when pressure is relieved from the pressure points the connector will be firmly restrained. In this manner, the cable attaching the two mated connectors can be pulled on and/or shaken and it will not become disconnected.

In an alternative preferred embodiment, a single prong can be placed on one of the long sides of the USB connector such as on a standard RJ11 or RJ45 telephone type connector. This single clip mates with a receptacle on the connection port, facilitating a physically secure connection. While this connection can be broken if the cable is pulled on subject to extraordinary pulling, it will provide sufficient strain resistance for ordinary stress.

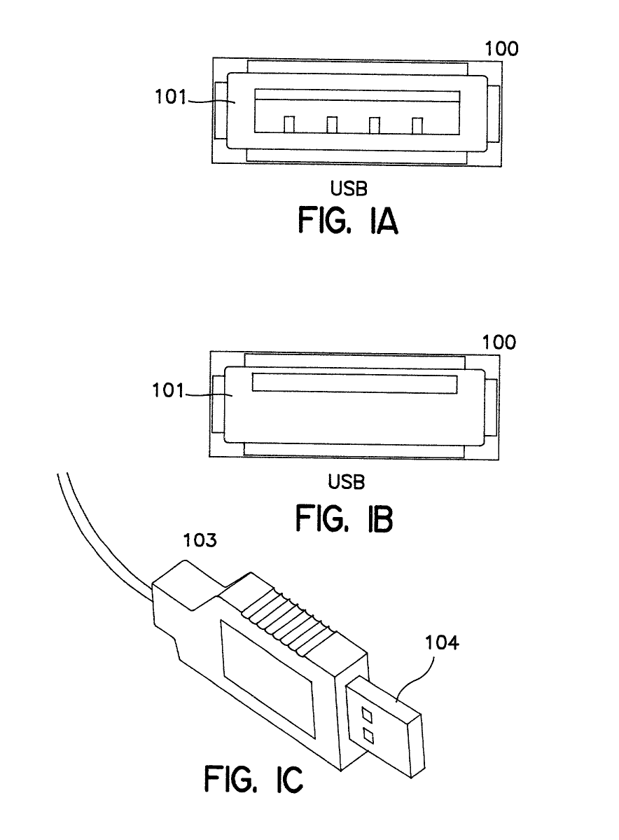

The details of the present invention will now be discussed with specific reference to the figures. FIGS. 1A and 1B illustrate two different views of a standard USB port 100 such as is notoriously well known in the computer arts. The port 100 consists of a tongue-like contact card 101 that makes electrical contact with a shroud 104 that is attached to any USB connector 103. This connector 100 affords easy connection and disconnect of peripheral devices which comport to the USB standard. FIG. 1C illustrates a typical USB connector 103. The connector 103 possesses a shroud 104 which surrounds the tongue-like contact card 101 of the USB port 100, making an electrical connection with the computer to which the port 100 is attached, facilitating the transfer of data. It is the friction between the shroud 104 and the tongue-like contact card 101 that maintains the continuity of the connection between the USB port 100 and the USB connector 103. In desktop environments, this connection is quite useful because it permits easy exchange of USB compliant devices such as digital cameras, scanners, zip drives, etc. However, because there is no fastener, mere friction alone is not always enough to maintain the connection of a USB connector 103 to USB port 100 when the connector 103 is used on a mobile or wearable computer, or any other environment where the connection is subject to motion or pull on the cable.

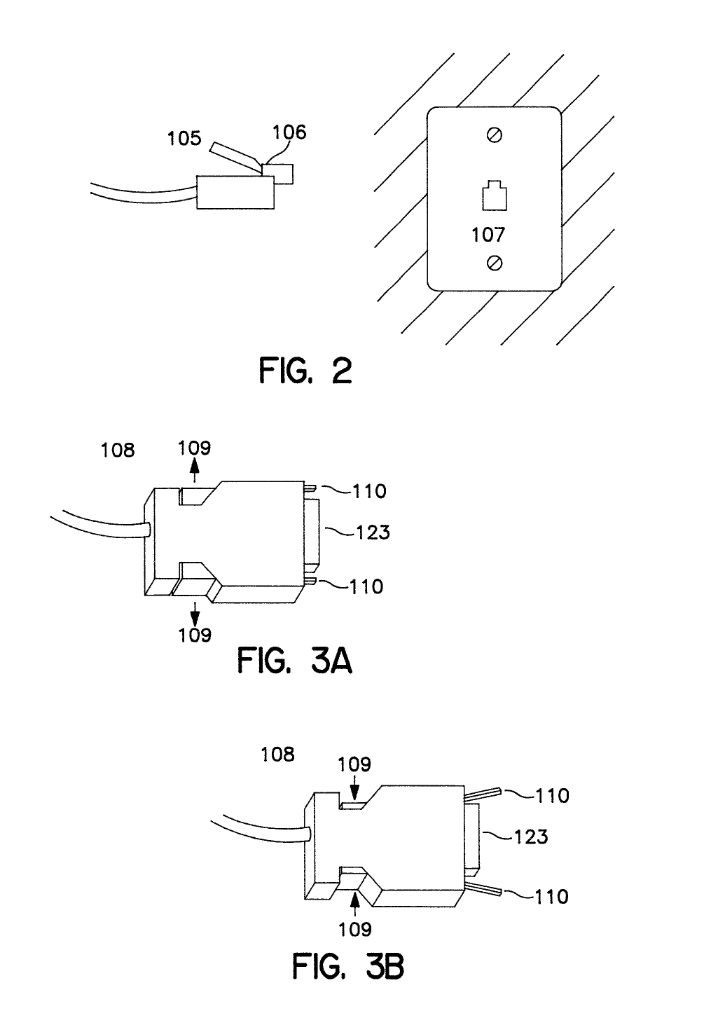

Various connector types are well known in the computer and cable design arts. They are typically used in environments where connections may be subject to stress or where they are usually maintained on a nearly permanent basis. FIG. 2 illustrates an RJ45/11 type connector 105 and connector plate 107. These connectors are used for telephone cables and local area network computer connections. The connector 105 has a single clip 106 on either the top or bottom, depending upon the orientation of the outlet 107, which securely fastens the connector to the outlet 107. In order to remove the connection, a person must squeeze the clip 106 to allow the connector 105 to slide smoothly out of the outlet 107. FIGS. 3A and 3B demonstrate another connector type also frequently employed in the computer arts for video monitors and other standard and nonstandard connections. This connector will be referred to as a squeeze clip-type connector 108. The connector 108 possesses a pair of squeezable buttons 109 which are fully extended outward when in the natural position and a set of restraining pins or clips 110. These pins move inversely to the clips 110 which grab or secure the connector to its port. When the a user squeezes the buttons 109, the clips 110 open outward allowing the user to mate the actual connector 123 with a port. Once the connection is in place, releasing the buttons 109 causes the clips 110 to return to their natural position. The connector 108 is now securely fastened to the port and will not become disconnected until someone squeezes the buttons 109 to release it.

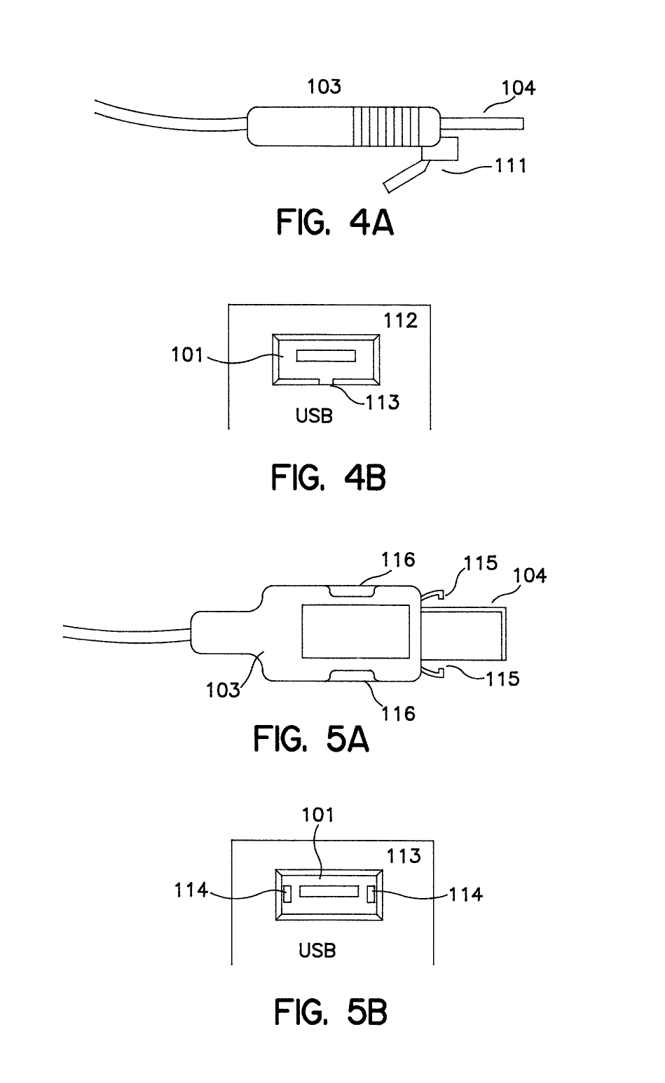

Either of the aforementioned fastening means can be employed in the present invention to securely fasten a USB connector to a USB port in a manner that is quickly disconnected by a user when he desires to do so but does not become disconnected accidentally. Refer to FIGS. 4A and 4B. FIG. 4A illustrates a modified USB connector 103 which has the standard connection shroud 104, but also has clip 111 similar to that which is used in an RJ45/11 connector 105. The clip 111 is depressed with a finger while the connector 103 is inserted into the USB port. FIG. 4B illustrates an embodiment of the modified USB port 112 of the present invention which is integral to a computing device. The port contains the standard connection interface, the tongue-like connection card 101, but also contains a grove 113 to accommodate the clip 111 of the modified USB connector 103. The clip 11 and grove 113 fit together when the connector 103 is mated with the port 112 forming a secure connection that can withstand moderate tension and movement without coming disconnected. However, if a user desires to disconnect, it can easily be done by applying pressure to the clip 111 and pulling the connector 103 out of the port 112.

FIG. 5A illustrates an embodiment of the present invention wherein the SUB connector 103 is modified to include integral buttons 116 which effect movement of squeeze clips 115. In order to fasten the connector 103, a user simply applies pressure to the buttons 116 and inserts the shroud 104 into the port 113 to mate with the tongue-like contact card 101. Once the shroud 104 is inserted all the way, pressure from the buttons is released, causing the clips 115 to return to their normal position and to secure the USB connector 103 to the USB port 113. In order the facilitate this, the port 113 itself must possess retraining brackets 114 for the clips 115 to mate with. Refer to FIG. 5B. FIG. 5B illustrates a USB port embodiment of the present invention for mating with the a USB connector 103 with squeeze clips 115. The port 113 comports with the USB standard, possessing an tongue-like contact card for mating with the shroud 104 of the USB connector 103, but also possesses a pair of restraining brackets 114 to physically secure the clips 115 of the modified USB connector 103.

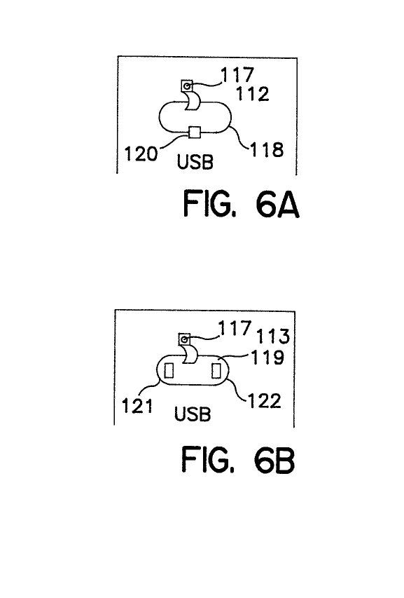

By incorporating a securing means into the USB port, a dust or protective cover can also be attached using the same securing means. In this manner, the contact card 101 of the USB port 100 can be protected from dust and exposure since a wearable computer will be use in several different environments, such as deserts, mountain terrain, dusty factories, farm land, etc. Again, this feature adds particular utility to portable and wearable computers which are more likely to be exposed to environments which could degrade or damage the electrical contact portion 101 of a USB port 100. By keeping a securely fastened dust cover attached to the port 100 when not in use, the usable life of the port 100 will be extended and it will be less vulnerable to exposure to moisture, dust and elements. FIG. 6A illustrates an embodiment of the present invention wherein a dust cover 118 is fixable attached to a computer by a screw 117 or other attaching means.

One possessing ordinary skill in the art will understand that many other constructive embodiments for the fastening mechanism can be imagined which differ in design but do not depart in spirit or scope from the teaching of the present invention. In fact, the invention at its essence is not directed specifically to the nature of the fastening mechanism, but rather to the idea of incorporating a fastening mechanism to a USB connector to solve the problem of accidental and/or unintentional disconnection of peripherals in the field of wearable and mobile computing.

The preferred and optimally preferred embodiments of the present invention that have been described herein illustrate the underlying principles of the invention, but it is to be understood that numerous modifications and ramifications may be made without departing from the spirit and scope of this invention.

We claim:

1. A USB connector for user supported computers comprising:
A USB port in said user supported computer for receiving a USB connector;
Fastening means on said connector for securing said connector to said port;
Reciprocal fastening means on said port for receiving and securing said connector.

2. The USB connector of claim 1 wherein said fastening means comprises a single fastener.

3. The USB connector of claim 1 wherein said fastening means comprises a pair of fasteners.

4. A secure USB connector port pair for mobile and wearable computers comprising:
A USB port on a computer;
A USB compliant connector;
A pressure activated mechanical fastening means on said connector;
A reciprocal receiving means on said port for receiving said fastening means.

5. A USB connector according to claim 4 wherein said port possesses a dust cover fixably attached thereto, said dust cover permitting a USB connector to mate with said port, said cover further engaging said receiving means when said port is not in use.
